(19) United States
(12) Patent Application Publication
(10) Pub. No.: US 2006/0265451 A1
(43) Pub. Date: Nov. 23, 2006

(54) Group communication system, server apparatus and floor control method

(75) Inventor: Hiroyuki Tomimori, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/435,147

(22) Filed: May 17, 2006

(30) Foreign Application Priority Data
May 18, 2005 (JP) 144812/2005

(51) Int. Cl. G06F 15/16

(52) U.S. Cl. 709/204

(57) ABSTRACT

To provide a group communication system capable of making a variety of controls in the group communication system. Communication means of a server apparatus communicates via a network with terminal devices, session control means of the server apparatus establishes a session between the terminal devices and coordinates a floor control policy. Floor control means of the server apparatus makes a floor control upon a request from the terminal devices, and data control means of the server apparatus distributes the data transmitted from the terminal device of the user to the terminal devices of other users participating in the session, after the session is established. A floor control policy storage part stores the information regarding the floor control, and a floor state storage part manages the number of floors granted currently to the user and the user who is granted the floor among the floors allocated to each media group.

### BACKGROUND OF THE INVENTION

1. Field of the Invention

The present invention relates to a group communication system, a server apparatus and a floor control method, and particularly to a floor (data transmission right) control method in a system that provides communications within a group composed of a plurality of terminal devices [e.g., PC (Personal Computer), portable telephone, and control equipment] (transmission and reception of a plurality of pieces of data such as sound, video, text and control information within a group).

2. Description of the Related Art

Conventionally, a floor control method is employed to control the user terminal capable of transmitting the data such as sound and text in a system that provides a group communication service such as an audiographic conference, a television (TV) conference, or a PTT (Push To Talk) (e.g., refer to Ericsson, Motorola, Nokia, Siemens, Push-to-Talk over Cellular (PoC); Architecture; Poc Release 1.0 [online], October, 2003, Ericsson, Motorola, Nokia, Siemens, Push-to-Talk over Cellular (PoC); User Requirements; Poc Release 1.0 [online], October, 2003, and Ericsson, Motorola, Nokia, Siemens, Push-to-Talk over Cellular (PoC) User Plane; Transport Protocols; Poc Release 1.0 [online], October, 2003, pages 9 to 25).

The system that provides the communications within the group includes a user terminal (client) that the service user employs and a server for establishing a communication session between group members, distributing the data and controlling the floor (data transmission right).

The user selects the partner (one or more users or group) making the group communications at the user terminal, and requests the server to establish a communication session. The server establishes the session with another user terminal or group member terminal designated in accordance with a request from the user terminal.

When the user wants to transmit the data such as sound or text to the participants in the session after the establishment of session is successful, the server is requested beforehand to acquire the floor. The server checks whether or not any other participant has already acquired the floor. If the floor is not acquired, the floor is granted to the user, or if the floor is acquired, the acquirement of the floor is refused.

If the floor acquirement is successful, the user transmits the data such as sound or text from the user terminal to the server. The server checks whether or not the user of the user terminal that transmits the data possesses the floor. If the floor is possessed, the data is distributed to the other participants.

The conventional floor control method has a problem that when various data such as video, text, image, location information and control information are transmitted or received within one communication session, the floor control can not be made for individual data or groups.

For example, in a communication session in which the video, text and image are transmitted or received, it is impossible to provide the control so that while a user is transmitting the video, the other users can transmit either the text or the image. This is because the above-mentioned function is not considered in the conventional floor control method.

Also, the conventional floor control method has another problem that because the floor control function for individual data or groups is not considered, a user employing the group communication service can not select a floor control method.

### BRIEF SUMMARY OF THE INVENTION

It is an object of the invention to solve the above-mentioned problems, and to provide a group communication system, a server apparatus and a floor control method in which a variety of controls can be made in the group communication system.

Also, it is another object of the invention to provide a group communication system, a server apparatus and a floor control method, which can be flexibly customized by the user.

The present invention provides a group communication system for transmitting or receiving data between terminal devices, while a server apparatus controls a data transmission right, the system comprising means for classifying the data from the terminal device into groups sharing the control of the data transmission right, and controlling the data transmission right for the data in a unit of group.

In the group communication system, the terminal device designates the number of groups used in a communication session, the number of data transmission rights allocated to each group, and data belonging to each group at the time of establishing the session.

The invention provides a server apparatus for controlling a data transmission right in a group communication system for transmitting or receiving data between terminal devices, the server apparatus comprising means for classifying the data from the terminal device into groups sharing the control of the data transmission right, and controlling the data transmission right for the data in a unit of group.

The server apparatus coordinates the number of groups used in a communication session, the number of data transmission rights allocated to each group and data belonging to each group, which are designated by each terminal device at the time of establishing the session.

The invention provides a floor control method for use in a group communication system for transmitting or receiving data between terminal devices while a server apparatus controls a data transmission right, the method comprising a step of classifying the data from the terminal device into groups sharing the control of the data transmission right, and a step of controlling the data transmission right for the data in a unit of group.

In the floor control method, the terminal device designates the number of groups used in a communication session, the number of data transmission rights allocated to each group, and data belonging to each group at the time of establishing the session.

That is, a group communication system according to the invention comprises a floor control policy storage part for storing the information on groups into which data transmitted or received in a communication session are classified and in each of which the floor control is shared [this group is hereinafter referred to as a media group], and floor control means for making the floor control in a unit of media group in accordance with the information.

The group communication system according to the invention adopts the above configuration, in which when the floor of a media group is granted to a user, a variety of controls can be made in the group communication system by allowing the transmission of the data belonging to a different media group if the floor of the different media group is acquired.

Also, the group communication system according to the invention comprises the floor control means for coordinating the information such as the number of media groups, the type of data belonging to each media group, and the number of floors (the information is hereinafter referred to as a floor control policy) transmitted from each of the session participants to store its result in a floor control policy storage part, whereby a user can flexibly customize a floor control method.

As described above, in the group communication system according to the invention, since the floor control is performed in a unit of media group by classifying the data sharing the floor into a media group, when the video, text and image are transmitted and received within one session, for example, various floor controls can be made in which one user can transmit the text or image, irrespective of whoever transmits the video.

Also, in the group communication system according to the invention, the user can make a request for the floor control in establishing the session, whereby the user can customize the floor control method.

### BRIEF DESCRIPTION OF THE DRAWINGS

FIG. 1 is a block diagram showing the configuration of a group communication system according to an embodiment of the present invention;

FIG. 2 is a view showing a data example which a floor control policy storage part holds according to the embodiment of the invention;

FIG. 3 is a block diagram showing the configuration of a terminal device of FIG. 1;

FIG. 4 is a sequence chart showing the operation of establishing the session in the group communication system according to the embodiment of the invention;

FIG. 5 is a sequence chart showing the operation of acquiring a floor in the group communication system according to the embodiment of the invention;

FIG. 6 is a sequence chart showing the operation of transmitting the data in the group communication system according to the embodiment of the invention; and

FIG. 7 is a view showing a data example which the floor control policy storage part holds according to another embodiment of the invention.

### DETAILED DESCRIPTION OF THE PREFERRED EMBODIMENTS

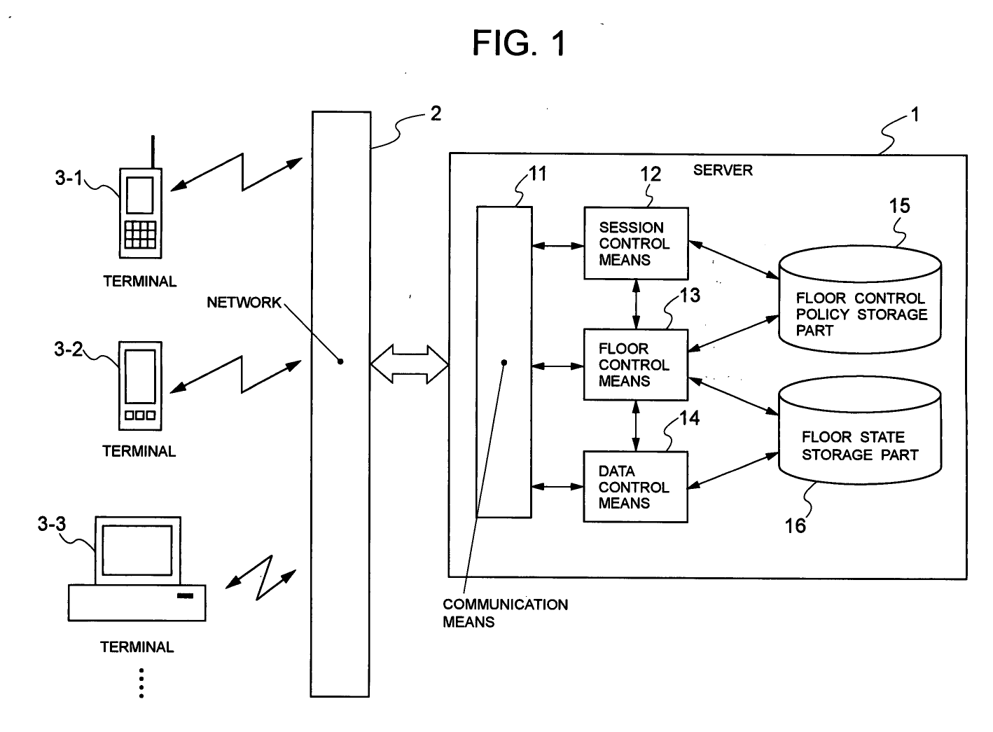

The preferred embodiments of the present invention will be described below with reference to the drawings. FIG. 1 is a block diagram showing the configuration of a group communication system according to a first embodiment of the invention. In FIG. 1, the group communication system comprises a server apparatus 1 for making the session establishment, data distribution and floor control, a network 2 and a terminal device 3-i (i=1, 2, 3, . . . ) such as a portable telephone or PDA (Personal Digital Assistant) that can be connected by wire or radio to the network 2, or other control devices.

The server apparatus 1 comprises communication means 11 of making the communications, session control means 12, floor control means 13, data control means 14, a floor control policy storage part 15 and a floor state storage part 16.

The communication means 11 communicates via the network 2 with the terminal device 3-i, and the session control means 12 establishes the communication session between the terminal devices and coordinates the floor control policy (information such as the number of media groups, type of data belonging to each media group, the number of floors).

The floor control means 13 controls the floor upon a request from the terminal device 3-i, and the data control means 14 distributes the data transmitted from the terminal device 3-1 of a user to the terminal devices 3-2, 3-3 of other users participating in the session after the session is established.

The floor control policy storage part 15 stores the information regarding the floor control, and the floor state storage part 16 manages the number of floors granted currently to users among the floors allocated to each media group (group of terminals grouped in a unit of sharing the floor control) and the user who is granted the floor.

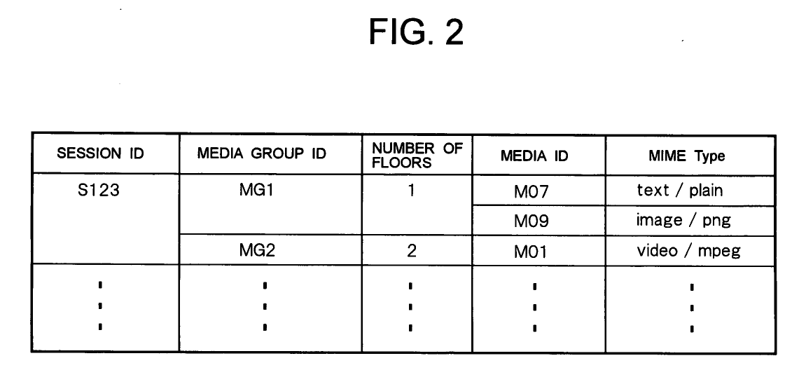

Referring to FIG. 2, the floor control policy storage part 15 holds a session ID of currently established session, a media group ID of media group contained in each session, the number of floors allocated to each media group, a media ID of data transmitted or received in each media group, and its type [MIME (Multipurpose Internet Mail Extensions) Type].

In an example of FIG. 2, a session “S123” has two media groups (“MG1”, “MG2”), the media group “MG1” is allocated one floor, in which two kinds of data “text/plain” and “image/png” are transmitted or received. The media group “MG2” is allocated two floors, in which one kind of data “video/mpeg” is transmitted or received.

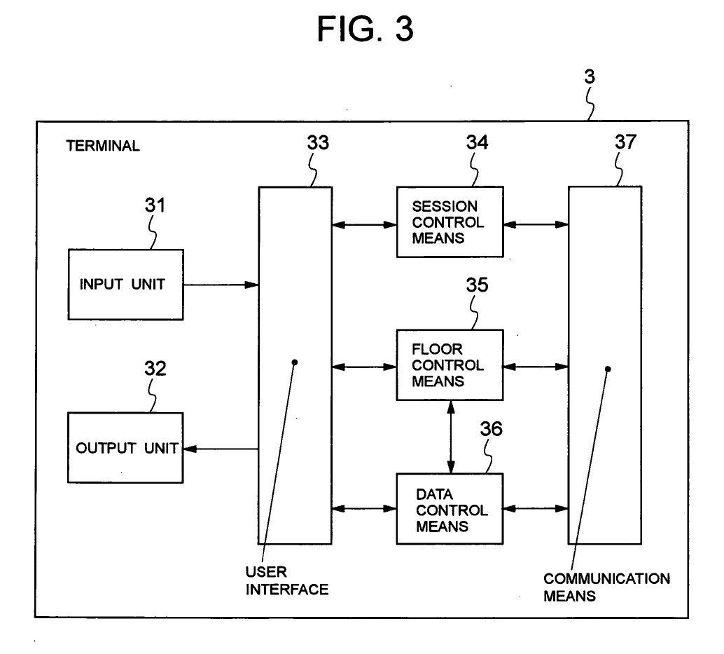

FIG. 3 is a block diagram showing the configuration of the terminal device 3-i of FIG. 1. In FIG. 3, the terminal device (client) 3 comprises an input unit 31 such as a keyboard or a microphone, an output unit 32 such as a display or a speaker, a user interface 33 for providing the interface between the user and the group communication system via the input unit 31 and the output unit 32, session control means 34 of controlling the establishment of communication session with other terminal devices, floor control means 35 of controlling the acquirement or release of the floor, data control means 36 of transmitting the data to the server apparatus 1 or receiving the data from the server apparatus 1, and communication means 37 of making the communication via the network 2 with the server apparatus 1.

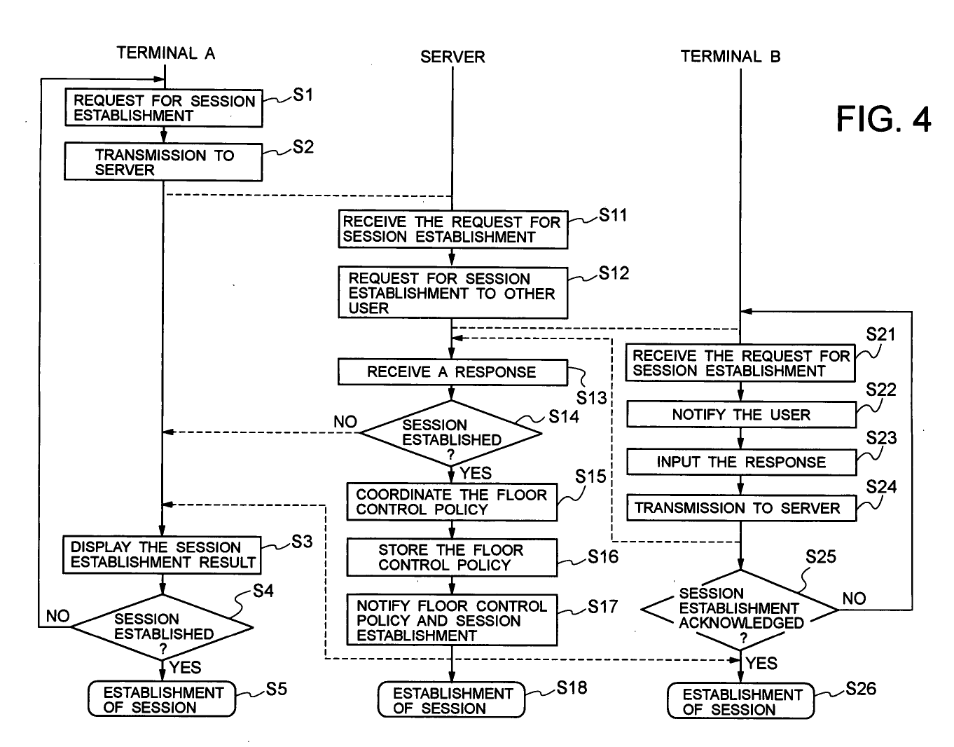

FIG. 4 is a sequence chart showing the operation of establishing the session in the group communication system according to the first embodiment of the invention. Referring to FIGS. 1 to 4, the operation of establishing the communication session in the group communication system according to the first embodiment of the invention will be described below.

When the user of the terminal device A (e.g., terminal device 3-1) establishes the communication session with the user of the terminal device B (e.g., terminal devices 3-2, 3-3), the user of the terminal device A requests the session control means 34 to establish the session with the information regarding the user address of the terminal device B and the floor control policy via the user interface 33 and the input unit 31 (step S1 of FIG. 4).

Herein, the user address is the information capable of identifying the partner terminal or user such as an SIP (Session Initiation Protocol) address or mail address, and the floor control policy includes the information such as the number of media groups requiring the independent floor control in the session, the number of floors allocated to each media group, and the MIME Type of data to be transmitted or received in each media group.

The session control means 34 receives a request for session establishment from the user interface 33, appends the user address and the floor control policy to the request, and transmits the request via the communication means 37 and the network 2 to the server apparatus 1 (step S2 of FIG. 4).

If the communication means 11 of the server apparatus 1 receives the request for session establishment from the terminal device A (step S11 of FIG. 4), the information is notified to the session control means 12. The session control means 12 request the user of the terminal device B designated by the terminal device A to establish the session via the communication means 11 and the network 2 (step S12 of FIG. 4). At this time, the information regarding the floor control policy requested by the terminal device A is appended.

If the terminal device B receives the request for session establishment from the server apparatus 1 (step S21 of FIG. 4), the request is notified to the session control means 34 of the terminal device B. The session control means 34 notifies the user of the terminal device B through the user interface 33 and the output unit 32 of the request for session establishment from the terminal device A and the floor control policy requested by the terminal device A (step S22 of FIG. 4).

The user of the terminal device B judges whether or not the establishment of session is acknowledged. If acknowledged, a desired floor control policy is passed through the input unit 31 and the user interface 33 to the session control means 34 (step S23 of FIG. 4). The session control means 34 transmits the information via the communication means 37 and the network 2 to the server apparatus 1 (step S24 of FIG. 4).

If the user of the terminal device B refuses the establishment of session (step S25 of FIG. 4), the procedure returns to a state before receiving the request for session establishment, or if the establishment of session is acknowledged (step S25 of FIG. 4), the procedure waits for a notification of the floor control policy from the server apparatus 1 (step S17 of FIG. 4), and transits to a state during the session establishment in which the data can be transmitted or received between the session participants (steps S5, S18, S26 of FIG. 4). The above processing of the terminal device B is likewise performed by the terminal devices 3-2 and 3-3.

If the communication means 11 of the service apparatus 1 receives a response to the request for session establishment from the terminal device B (step S13 of FIG. 4), the response is notified to the session control means 12. If the session control means 12 receives the response for refusing the establishment of session from the terminal device B, a session failure is transmitted via the communication means 11 and the network 2 to the terminal device A (step S14 of FIG. 4).

If the session control means 12 receives a response for acknowledging the session establishment from the terminal device B (either the terminal device 302 or 303, or both), the server apparatus 1 coordinates the floor control policy (step S15 of FIG. 4). That is, the final floor control policy is determined based on the floor control policy requested by the terminal device A and the floor control policy requested by the terminal device B acknowledging the session establishment.

For example, a) even in a case where the terminal device A requests a media group containing “video/mpeg” in the floor control policy, the media group is withdrawn, if the terminal device B does not request the transmission/reception of “video/mpeg”, b) in a case where the terminal device A requests the allocation of two floors to a media group containing “video/mpeg”, one floor is allocated to the media group, if the terminal device B requests the allocation of only one floor, or c) in a case where all the terminal devices A and B request the allocation of two floors to a media group containing “video/mpeg”, the number of floors is set to 1 in consideration of the function of the server apparatus 1 or the load of the network 2.

After determining the floor control policy, the session control means 12 stores the determined floor control policy in the floor control policy storage part 15 (step S16 of FIG. 4). Thereafter, the successful session establishment and the determined floor control policy are transmitted via the communication means 11 and the network 2 to the terminal device A and the terminal device B acknowledging the session establishment (step S17 of FIG. 4).

The communication means 37 passes the information to the session control means 34, which displays the information on the output unit 32 through the user interface 33 (step S3 of FIG. 4).

The terminal device A transits to a state during the session establishment in which the data can be transmitted or received between the session participants, if the session establishment is successful, or returns to a state before requesting the session establishment, if the session establishment is unsuccessful (step S4 of FIG. 4).

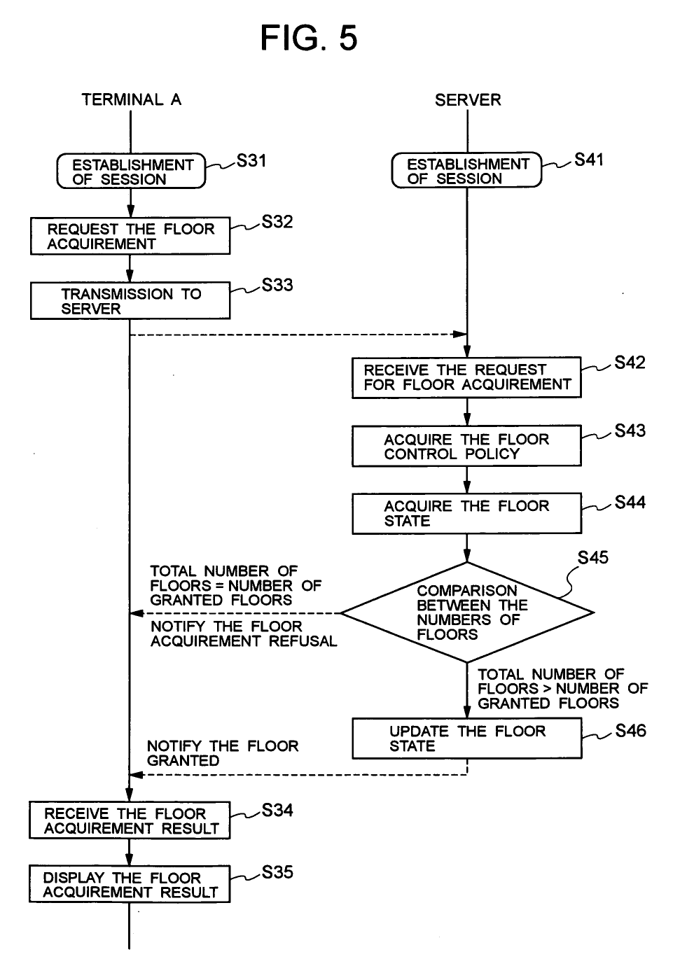

FIG. 5 is a sequence chart showing the operation of acquiring the floor in the group communication system according to the first embodiment of the invention. Referring to FIGS. 1 to 3 and FIG. 5, the operation where the terminal device A requests the server apparatus 1 to acquire the floor after establishing the communication session in the group communication system according to the first embodiment of the invention will be described below. The floor control policy of session in this embodiment is shown in FIG. 2.

That is, two media groups (media group ID=“MG1”, “MG2”) exist in the currently established session (session ID=“S123”), in which the media group “MG1” is allocated one floor, and the media group “MG2” is allocated two floors. Also, the floor control objects of the media group “MG1” include “text/plain” (media ID=“M07”) and “image/png” (media ID=“M09”), and the floor control objects of the media group “MG2” include “video/mpeg” (media ID=“M01”).

After establishment of the communication session (steps S31 and S41 of FIG. 5), when the user of the terminal device A tries to transmit the data belonging to the media group “MG1”, the user requests the floor control means 35 to acquire the floor for the media group “MG1” via the input unit 31 and the user interface 33 (step S32 of FIG. 5).

The floor control means 35 transmits its request via the communication means 37 and the network 2 to the server apparatus 1 (step S33 of FIG. 5). In the server apparatus 1, if the communication means 11 receives a floor acquirement request from the terminal device A (step S42 of FIG. 5), it is notified to the floor control means 13.

The floor control means 13 retrieves the floor control policy storage part 15, and acquires the total number of floors allocated to the media group (media group ID=“MG1”) designated by the terminal device A from the floor control policy associated with the currently established session (step S43 of FIG. 5).

Then, the floor control means 13 acquires the number of floors granted currently to users among the floors allocated to the media group (media group ID=“MG1”) designated by the terminal device A from the floor state storage part 16 (step S44 of FIG. 5).

Thereafter, the floor control means 13 compares the total number of floors acquired at step S43 with the number of granted floors acquired at step S44 (step S45 of FIG. 5). If the number of granted floors does not exceed the total number of floors, the number of granted floors for the media group “MG1” managed by the floor state storage part 16 is increased by 1, and the user who is newly granted the floor is stored in the floor state storage part 16 (step S46 of FIG. 5), in which it is notified the terminal device A via the communication means 11 and the network 2 that the floor is granted. Also, the floor control means 13 notifies the refusal of floor acquirement to the terminal device A, if the number of granted floors is equal to the total number of floors.

If the floor control means 35 of the terminal device A receives the result of floor acquirement via the communication means 37 (step S34 of FIG. 5), it is outputted via the user interface 33 to the output unit 32 (step S35 of FIG. 5).

If the terminal device A is successful in acquiring the floor for the media group “MG1”, the data for “text/plain” (media ID=M07) and “image/png” (media ID=M09) belonging to the media group “MG1” can be transmitted.

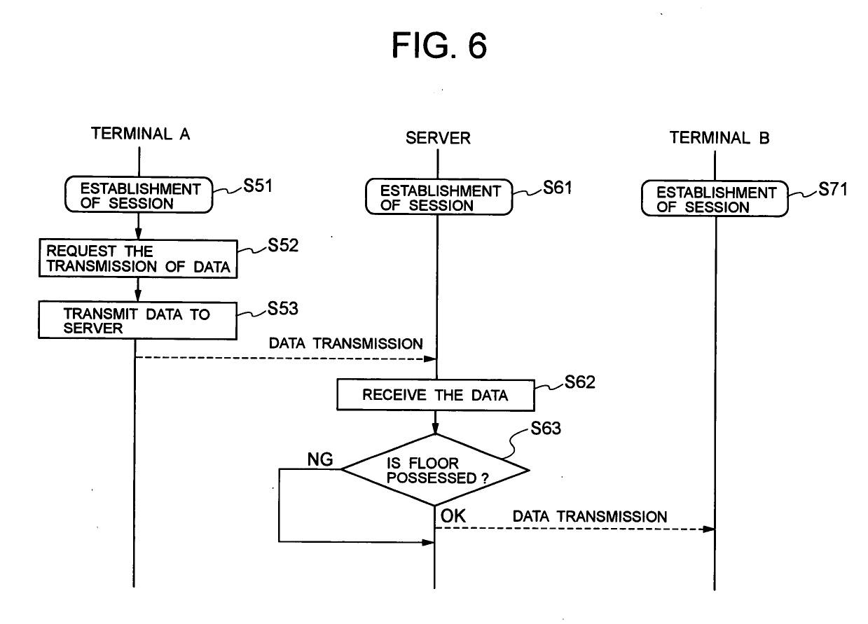

FIG. 6 is a sequence chart showing the operation of transmitting the data in the group communication system according to the first embodiment of the invention. Referring to FIGS. 1 to 3 and FIG. 6, the operation where the terminal device A transmits the data belonging to the media group “MG1” to the terminal device B participating in the session in the group communication system according to the first embodiment of the invention will be described below.

After establishment of the communication session (steps S51, S61 and S71 of FIG. 6), the user of the terminal device A requests the data control means 36 to transmit the data via the input unit 31 and the user interface 33 (step S52 of FIG. 6). The data control means 36 transmits the data to the server apparatus 1 via the communication means 37 and the network 2 (step S53 of FIG. 6).

The server apparatus 1 passes the data to the data control means 14, if the communication means 11 receives the data from the terminal device A (step S62 of FIG. 6). The data control means 14 investigates the floor state storage part 16, and checks whether or not the floor of the media group “MG1” to which the data transmitted by the terminal device A belongs is possessed by the user of the terminal device A (step S63 of FIG. 6). Only if the user possesses the floor, the data is transmitted to the terminal device B participating in the session.

In this manner, since the floor control is made in a unit of media group according to the first embodiment, when a plurality of pieces of data are transmitted or received, a variety of floor controls can be implemented depending on the combination of classifying the data into the media groups. Also, since the user can request the number of media groups, the number of floors or the like in this embodiment, the flexible floor controls can be implemented.

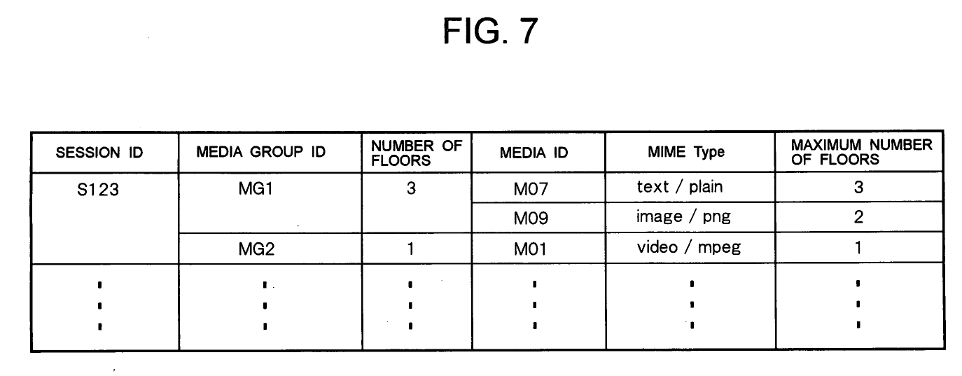

FIG. 7 is a view showing a data example held by the floor control policy storage part according to a second embodiment of the invention. The configuration of the group communication system, the configuration of the server apparatus, and the configuration of the terminal device according to the second embodiment of the invention are the same as those in the first embodiment of the invention. In the second embodiment of the invention, the floor control policy held by the floor control policy storage part 15 is different from that of the first embodiment of the invention in that the maximum number of floors for each data is provided, in addition to the information as shown in FIG. 2, and the floor state storage part 16 stores the number of granted floors for each data, besides the number of granted floors for each media group and the information regarding the user who is granted the floor.

In the first embodiment of the invention, since each floor allocated to a media group is regarded as the right to transmit all the data belonging to the media group, the user who acquires the floor of certain media group can transmit all the data belonging to the media group. On the contrary, in the second embodiment of the invention, each floor allocated to a media group is regarded as the right to transmit one type of data belonging to the media group.

The user designates the media group ID and the media ID at the time of requesting the floor acquirement, and if the floor is acquired, only the data designated at the time of requesting the floor acquirement can be transmitted.

In FIG. 7, the maximum number of floors designated for each data defines how many users at maximum can acquire the floors for transmitting the data concurrently. In an example as shown in FIG. 7, three floors are allocated to the media group “MG1”. Since the maximum number of floors for “image/png” (media ID=M09”) is 2, up to two users can acquire the floor for “image/png”. Even if two users acquire the floor for “image/png”, the other one user can acquire the floor for “text/plain”, because one remaining floor exists in the media group “MG1”.

Referring to FIG. 1 and FIGS. 3 to 7, the operation of the group communication system according to the second embodiment of the invention will be described below. In the second embodiment, the operation of establishing the communication session is the same as that explained at steps S1 to S5, S11 to S18, and S21 to S26 in FIG. 4, except that the maximum number of floors for each data is included in the floor control policy.

The operation in which the terminal device A requests the server apparatus 1 to acquire the floor will be described below. Herein, the different points of the operation as shown in FIG. 5 from the operation of the first embodiment of the invention will be described below.

At step S32 of FIG. 5, the user of the terminal device A requests the acquirement of floor by designating the media group ID and the media ID. Also, the total number of floors (“a”) allocated to the media group designated by the terminal device A and the maximum number of floors (“b”) allocated to the media ID designated by the terminal device A are acquired from the floor control policy storage part 15 at step S43.

At step S44, the number of granted floors (“c”) for the media group designated by the terminal device A and the number of granted floors (“d”) for the media ID designated by the terminal device A are acquired from the floor state storage part 16.

Thereafter, at step S45, the numbers of floors “a”, “b” acquired at step S43 and the numbers of floors “c”, “d” acquired at step S44 are compared respectively. At step S46, if “c”<“a” and “d”<“b” hold, the numbers of granted floors “c”, “d” managed by the floor state storage part 16 are incremented by 1, and the user who is newly granted the floor is stored in the floor state storage part 16.

If the condition of step S45 holds, it is notified the terminal device A via the communication means 11 and the network 2 that the floor is granted, or if the condition of step S45 does not hold, the refusal of floor acquirement is notified to the terminal device A.

Next, the operation where the terminal device A transmits the data to the terminal device B participating in the session will be described below. Herein, the different points of the operation as shown in FIG. 6 from the operation of the first embodiment of the invention will be described below.

At step S63, the data control means 14 investigates the floor state storage part 16, and checks whether or not the floor corresponding to the data transmitted by the terminal device A is possessed by the user of the terminal device A. Only if the user possesses the floor, the data is transmitted to the terminal device B participating in the session.

In this manner, since a floor is regarded as the right to transmit one type of data belonging to a media group, and the upper limit is set to the number of floors grantable concurrently to users for each data, whereby the floor control for each data can be made within a range of the number of floors allocated to the media group, so that a variety of controls can be made more effectively than the first embodiment of the invention.

This invention is applicable to a television (TV) conference system and a Push To Talk service dealing with the transmission or reception of various kinds of data such as sound, text, image, video and location information, a group communication service for transmitting or receiving specific data specialized to an individual business (category of business), and an equipment control system for transmitting or receiving data on the equipment or control data between the person and the equipment.

What is claimed is:

1. A group communication system for transmitting or receiving data between terminal devices, while a server apparatus controls a data transmission right, the system comprising means for classifying the data from the terminal device into groups sharing the control of the data transmission right, and controlling the data transmission right for the data in a unit of group.

2. The group communication system according to claim 1, wherein a plurality of data transmission rights are allocated to the group so that two or more terminal devices can acquire the rights to transmit the data belonging to the group concurrently.

3. The group communication system according to claim 1, wherein the data transmission right is the right to transmit all the data belonging to the group.

4. The group communication system according to claim 1, wherein the data transmission right is the right to transmit only one data belonging to the group.

5. The group communication system according to claim 4, wherein the terminal device requests the means to grant the data transmission right by designating the desired group and data.

6. The group communication system according to claim 4, wherein the maximum number of data transmission rights grantable concurrently to the terminal devices is set for each data belonging to the group.

7. The group communication system according to claim 1, wherein the terminal device designates the number of groups used in a communication session, the number of data transmission rights allocated to each group, and data belonging to each group at the time of establishing the session.

8. A server apparatus for controlling a data transmission right in a group communication system for transmitting or receiving data between terminal devices, the server apparatus comprising means for classifying the data from the terminal device into groups sharing the control of the data transmission right, and controlling the data transmission right for the data in a unit of group.

9. The server apparatus according to claim 8, wherein a plurality of data transmission rights are allocated to the group so that two or more terminal devices can acquire the rights to transmit the data belonging to the group concurrently.

10. The server apparatus according to claim 8, wherein the data transmission right is the right to transmit all the data belonging to the group.

11. The server apparatus according to claim 8, wherein the data transmission right is the right to transmit only one data belonging to the group.

12. The server apparatus according to claim 11, wherein the means grants the data transmission right to the terminal device based on the group and data designated by the terminal device.

13. The server apparatus according to claim 11, wherein the maximum number of data transmission rights grantable concurrently to the terminal devices is set for each data belonging to the group.

14. The server apparatus according to any one of claim 8, wherein the server apparatus coordinates the number of groups used in a communication session, the number of data transmission rights allocated to each group and data belonging to each group, which are designated by each terminal device at the time of establishing the session.

15. A floor control method for use in a group communication system for transmitting or receiving data between terminal devices while a server apparatus controls a data transmission right, the method comprising a step of classifying the data from the terminal device into groups sharing the control of the data transmission right, and a step of controlling the data transmission right for the data in a unit of group.

16. The floor control method according to claim 15, wherein a plurality of data transmission rights are allocated to the group so that two or more terminal devices can acquire the rights to transmit the data belonging to the group concurrently.

17. The floor control method according to claim 15, wherein the data transmission right is the right to transmit all the data belonging to the group.

18. The floor control method according to claim 15, wherein the data transmission right is the right to transmit only one data belonging to the group.

19. The floor control method according to claim 18, wherein the maximum number of data transmission rights grantable concurrently to the terminal devices is set for each data belonging to the group.

20. The floor control method according to claim 15, wherein the terminal device designates the number of groups used in a communication session, the number of data transmission rights allocated to each group, and data belonging to each group at the time of establishing the session.
